(19) United States
(12) Patent Application Publication
(10) Pub. No.: US 2008/0012423 A1
(43) Pub. Date: Jan. 17, 2008

(54) USB connector devices for charging

(76) Inventor: Emile Mimran, Long Branch, NJ (US)

Correspondence Address: EZRA SUTTON, P.A., Plaza 9 Building, 900 Route 9 North, Woodbridge, NJ, 07095, US

(21) Appl. No.: 11/485,751

(22) Filed: Jul. 13, 2006

(51) Int. Cl. H02J 3/00

(52) U.S. Cl. 307/11

(57) ABSTRACT

A universal serial bus (USB) adaptor device for use in pre-wiring of any office or home in order to have wall outlets and/or floor outlets available for charging of peripheral electronic devices. The USB adaptor device includes a plate having one or more openings. The openings are used for receiving a USB power supply module therethrough. The USB power supply module includes one or more USB connector ports thereto. Each of the USB connector ports are used for charging peripheral electronic devices selected from the group including cell phones, PDA's, MP3players, shavers, digital cameras, and games for using a USB-type plug in conjunction with the USB connector port.

### FIELD OF THE INVENTION

The present invention relates to a USB (universal serial bus) adaptor device having a plurality of USB connector ports attached thereto. More particularly, the USB adaptor device is used in the pre-wiring of any office or home in order to have wall outlets and/or floor outlets available for charging of peripheral electronic devices.

### BACKGROUND OF THE INVENTION

USB adaptor devices are well-known in the art. The USB was designed to allow peripherals to be connected without the need to plug expansion cards into the computer's ISA, EISA or PCI bus, and to improve plug-and-play capabilities by allowing devices to be hot-swapped (connected or disconnected without powering down or rebooting the computer). When a device is first connected, the host enumerates and recognizes it and loads the device driver it needs.

The USB can connect peripherals such as mice, keyboards, gamepads and joysticks, scanners, digital cameras, printers, external storage, networking components, etc. For many devices such as scanners and digital cameras, USB has become the standard connection method. USB is also used extensively to connect non-networked printers, replacing the parallel ports which were widely used; USB simplifies connecting several printers to one computer. As of 2004 there were about 1 billion USB devices in the world. As of 2005, the only large classes of peripherals that cannot use USB, because they need a higher data rate than USB can provide, are displays and monitors and high-quality digital video components. Presently, there are no USB connector/adaptor devices being used to pre-wire home or office wall outlets and/or floor outlets for charging of most types of peripheral electronic devices.

There remains a need for a USB adaptor device that can be used for the pre-wiring of any home or office in order to have wall and/or floor outlets being used to charge electronic devices, cell phones, PDA's, MP3 players, shavers, digital cameras, games, and other electronic devices.

### DESCRIPTION OF THE PRIOR ART

Network adaptor devices for communicating between computers and peripheral devices and the like having various designs, configurations and structures have been disclosed in the prior art. For example, U.S. Pat. No. 6,943,296 to PERELLA et al. discloses a USB wall plate having a first opening for receiving a USB connector therethrough and a second opening for receiving an indicating light therethrough. This prior art patent does not disclose ro teach the structure and configuration of the USB adaptor device for charging peripheral electronic devices of the present invention.

U.S. Publication No. 2004/0087214 to CHO discloses a network adaptor device such as a modulation bridge having a plurality of device ports wherein one is adapted to connect to a computer via a network line and the other one is adapted to connect to a peripheral via a USB line, a coaxial cable jack, a modular telephone jack and a power cord jack. Thus, the network adaptor device can connect to a power cord, telephone line cord, or coaxial cable for effecting a data transmission between a computer and a peripheral or between computers in the home network. This prior art publication does not disclose or teach the structure and configuration of the USB adaptor device for charging peripheral electronic devices of the present invention.

None of the prior art references teach or disclose the structure and configuration of USB adaptor devices for use in pre-wiring of any office or home in order to have wall outlets and/or floor outlets for charging electronic devices, cell phones, PDS's, MP3 players, iPODS and other peripheral electronic devices. Further, the aforementioned prior art references do not teach or disclose other types of USB adaptor devices, such as a USB plug-in module, a portable USB power strip, and a portable USB car plug-in module for a moving vehicle.

Accordingly, it is an object of the present invention to provide a USB adaptor device that is used in the pre-wiring of any office or home in order to have wall outlets and/or floor outlets for charging electronic devices, cell phones, PDA's, MP3 players, shavers, digital cameras, games, and other electronic devices.

Another object of the present invention is to provide a USB adaptor device that is in the form of a USB plug-in module for use in conjunction with standard AC receptacle wall outlets and/or floor outlets for charging peripheral electronic devices.

Another object of the present invention is to provide a USB adaptor device that is in the form of a portable USB power strip for use in conjunction with standard AC receptacle wall outlets and/or floor outlets for charging peripheral electronic devices.

Another object of the present invention is to provide a USB adaptor device that is in the form of a portable USB car plug-in module for a moving vehicle and for use in conjunction with standard vehicle power supply receptacles in order to charge peripheral electronic devices while driving.

Another object of the present invention is to provide a USB adaptor device that is easy to use, durable and long-lasting with no moving parts contained therein.

A further object of the present invention is to provide a USB adaptor device that can be mass-produced in an automated and economical manner and is readily affordable by the consumer.

### SUMMARY OF THE INVENTION

In accordance with the present invention, there is provided a universal serial bus (USB) adaptor device for use in pre-wiring of any office or home in order to have wall outlets and/or floor outlets available for charging of peripheral electronic devices. The USB adaptor device includes a plate having one or more openings. The openings are used for receiving a USB power supply module therethrough. The USB power supply module includes one or more USB connector ports thereto. Each of the USB connector ports are used for charging electronic devices selected from the group including cell phones, PDA's, MP3players, shavers, digital cameras, and games for using a USB-type plug in conjunction with the USB connector port. Optionally, the USB power supply module includes a built-in transformer member for changing the voltage from 110V or 220V to low voltages such as 1.5V, 2.5V or 4.0V in order to connect to low voltage electronic devices.

### BRIEF DESCRIPTION OF THE DRAWINGS

Further objects, features and advantages of the present invention will become apparent upon the consideration of the following detailed description of the presently-preferred embodiment when taken in conjunction with the accompanying drawings, wherein:

FIG. 1 is a front perspective view of the USB adaptor device of the preferred embodiment of the present invention showing an AC three-prong receptacle outlet, a USB power supply module having a plurality of USB connector ports, a wall plate, and a plurality of electronic devices connected to the connector ports with each electronic device having a USB-type plug, and also having an optional built-in transformer;

FIG. 2 is a front exploded perspective view of the USB adaptor device of the preferred embodiment of the present invention showing the adaptor's major component parts thereof, and also having an optional built-in transformer;

FIG. 3 is a front perspective view of the USB adaptor device of the first alternate embodiment of the present invention showing a USB power supply module having a plurality of USB connector ports and a wall plate, and also having an optional built-in transformer;

FIG. 4 is a front exploded perspective view of the USB adaptor device of the first alternate embodiment of the present invention showing the adaptor's major component parts thereof, and also having an optional built-in transformer;

FIG. 5 is a top perspective view of the portable USB power strip of the second alternate embodiment of the present invention showing a USB power strip having a power on/off toggle switch, a power-on indicator light, a power cord and plug, a plurality of AC receptacles (2 or 3 prongs) and a plurality of USB connector ports, and also having an optional built-in transformer;

FIG. 6 is a front perspective view of the portable USB plug-in module of the third alternate embodiment of the present invention showing a module housing having a plurality of USB connector ports on its front wall, and also having an optional built-in transformer;

FIG. 7 is a rear perspective view of the portable USB plug-in module of the third alternate embodiment of the present invention showing the module housing having a plurality of electrical prongs on its rear wall, and also having an optional built-in transformer;

FIG. 8 is a front perspective view of the portable USB car plug-in module of the fourth alternate embodiment of the present invention showing a module housing having a car plug-in section and a USB module section with a plurality of USB connector ports therein, and also having an optional built-in transformer;

FIG. 9 is a perspective view of portable USB cables used in the present invention showing a plurality of attachment USB cables having different USB port connectors attached thereto; and

FIG. 10 is a perspective view of portable USB cables used in the present invention showing a plurality of attachment USB cables having a built-in transformer member with different USB port connectors attached thereto.

### DETAILED DESCRIPTION OF THE PREFERRED AND ALTERNATE EMBODIMENT

### Preferred Embodiment 10

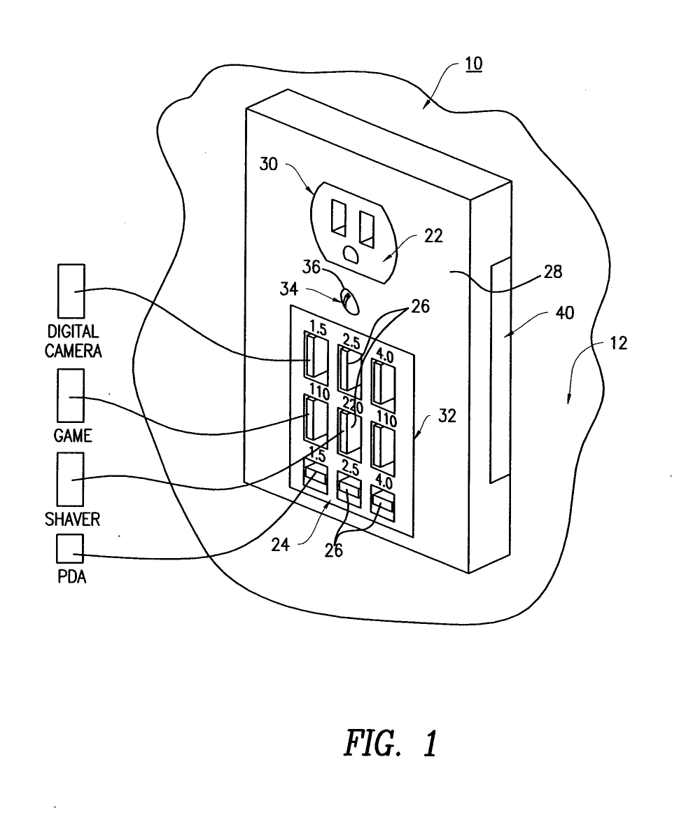

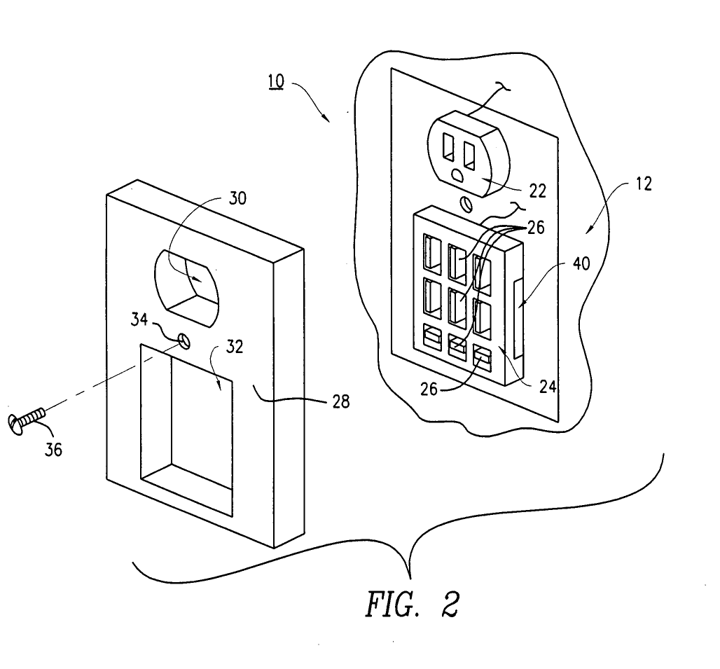

The USB wall adaptor 10 and its component parts of the preferred embodiment of the present invention are represented in detail by FIGS. 1 and 2 of the patent drawings. The USB wall adaptor 10 includes an AC three-prong receptacle 22, a USB power supply module 24 having a plurality of USB connector ports 26 therein, and a wall plate 28 for supporting the AC receptacle 22 and the USB power supply module 24 within an office or home wall 12, as shown in FIGS. 1 and 2 of the drawings. The plurality of USB connector ports 26 can vary in size and shape depending upon the type of USB plugs used by the user. Wall plate 28 includes a first opening 30 for receiving the AC receptacle 22 therethrough, a second opening 32 for receiving the USB power supply module 24 therethrough and a screw opening 34 for receiving a screw 36 therein in order to hold wall plate 28 to wall 12. The USB wall adaptor 10 is used to pre-wire any office or home in order to have wall and/or floor outlets for charging electronic devices, cell phones, PDA's, MP3 players, shavers, digital cameras games and other electronic devices.

Optionally, the USB power supply module 24 includes a built-in transformer member 40 for changing the voltage (V) from 110V or 220V, to low voltages such as 1.5V, 2.5V or 4.0V for connection to low voltage electronic devices, as shown in FIGS. 1 and 2 of the drawings.

### First Alternate Embodiment 100

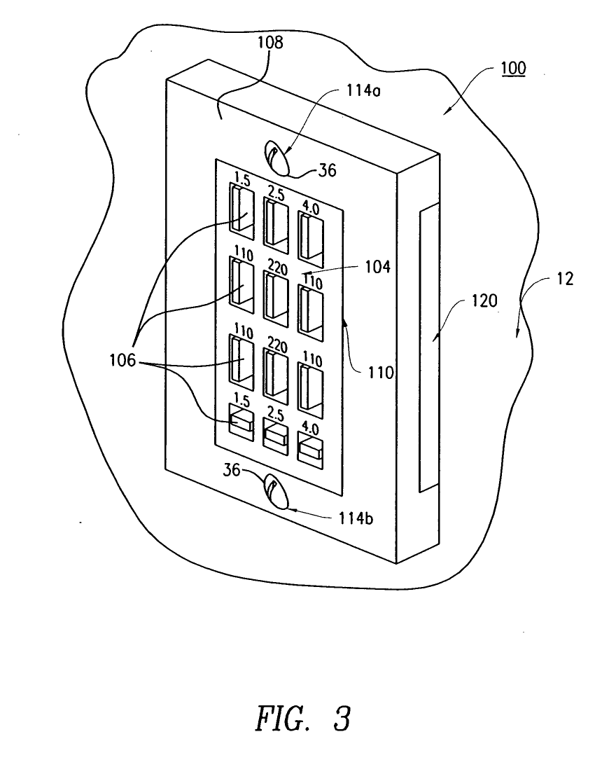

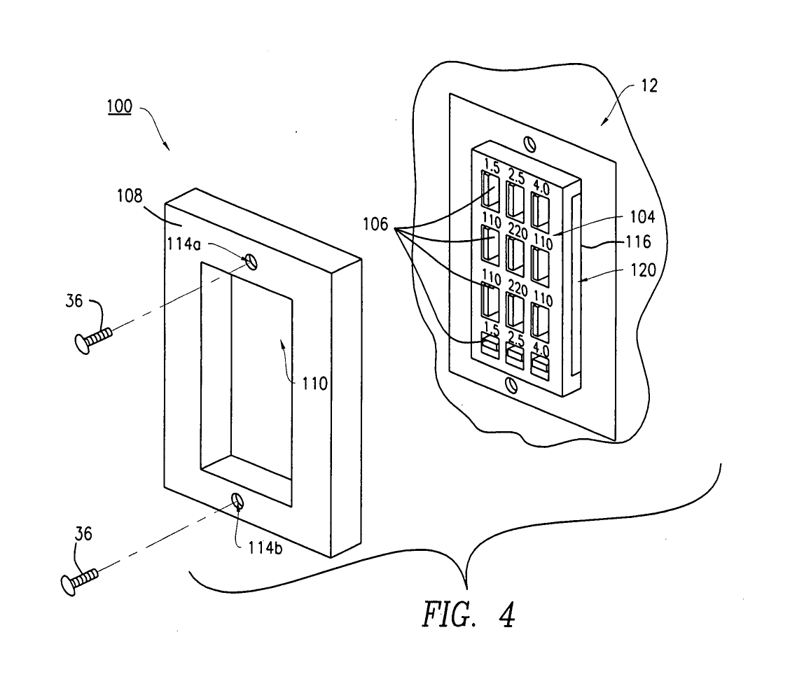

The USB wall adaptor 100 and its component parts of the first alternate embodiment of the present invention are represented in detail by FIGS. 3 and 4 of the patent drawings. The USB wall adaptor 100 includes a USB power supply module 104 having a plurality of USB connector ports 106 therein, and a wall plate 108 for supporting the USB power supply module 104 within an office or home wall 12, as depicted in FIGS. 3 and 4 of the drawings. The plurality of USB connector ports 106 can vary in size and shape depending upon the type of USB plugs used by the user. Wall plate 108 includes a module opening 110 for receiving the USB power supply module 104 therein and screw openings 114a and 114b each for receiving a screw 36 therein in order to hold wall plate 108 to wall 12. The USB wall adaptor 100 is used to pre-wire any office or home in order to have wall and/or floor outlets for charging electronic devices, cell phones, PDA's, MP3 players, shavers, digital cameras, games and other electronic devices. Optionally, the USB power supply module 104 includes a built-in transformer member 120 being adjacent to a rear section 116 of module 104. Transformer member 120 is used for changing the voltage (V) from 110 or 220 to low voltages such as 1.5V, 2.5V or 4.0V for connection to low voltage electronic devices, as shown in FIG. 4 of the drawings.

### Second Alternate Embodiment 200

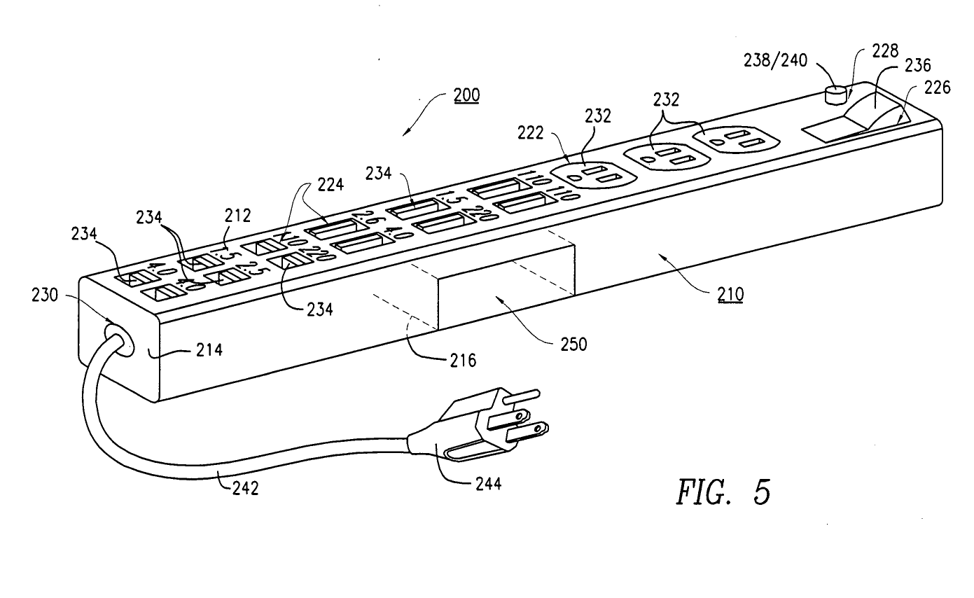

The portable USB power strip 200 and its component parts of the second alternate embodiment of the present invention is represented in detail by FIG. 5 of the patent drawings. The portable USB power strip 200 includes a power strip housing 210 being any shape, including rectangular in shape. The power strip housing 210 includes a top wall 212 having a plurality of AC receptacle openings 222, a plurality of USB connector port openings 224, a switch opening 226, a power-on light opening 228, a side wall 214 having a cord opening 230 and a rear wall 216. Each of the AC receptacle openings 222 are for receiving a plurality of AC three-prong receptacles 232, respectively, therethrough. Each of the port openings 224 are for receiving a plurality of USB connector ports 234, respectively, therethrough. The plurality of USB connector ports 234 can vary in size and shape depending upon the type of USB plugs used by the user. The switch opening 226 is for receiving a power toggle switch 236 therethrough and light opening 228 is for receiving a green power-on bulb covering 238 and power-on bulb 240 therethrough. Cord opening 230 is for receiving a power cord 242 and three-prong plug 244 therethrough. Optionally, the power strip housing 210 of portable USB power strip 200 includes a built-in transformer member 250 being adjacent to rear wall 216 of power strip housing 210. Transformer member 250 is used for changing the voltage(V) from 110 or 220 to low voltages such as 1.5V, 2.5V or 4.0V for connection to low voltage electronic devices. The USB power strip 200 is used in any office or home in conjunction with standard wall and/or floor outlets for charging electronic devices, cell phones, PDA's, MP3 players, shavers, digital cameras, games and other electronic devices.

### Third Alternate Embodiment 300

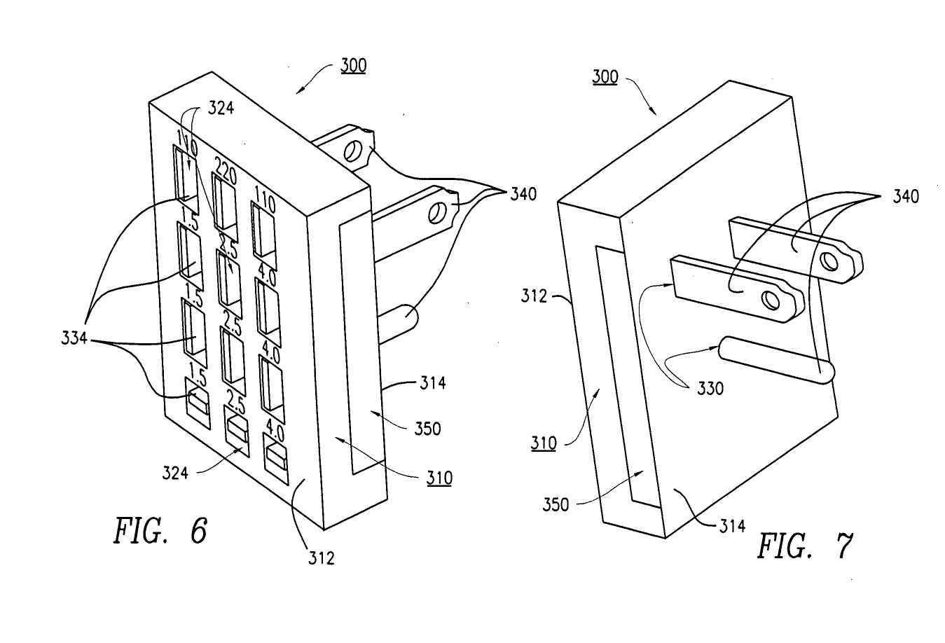

The portable USB plug-in module 300 and its component parts of the third alternate embodiment of the present invention are represented in detail by FIGS. 6 and 7 of the patent drawings. The portable USB plug-in module 300 includes a module housing 310 being any shape, including rectangular in shape. The module housing 310 includes a front wall 312 having a plurality of USB connector port openings 324 each for receiving a plurality of USB connector ports 334, respectively, therethrough. The plurality of USB connector ports 334 can vary in size an shape depending upon the type of USB plugs used by the user. The module housing 310 also includes a rear wall 314 having a plurality of electrical prong openings 330 each for receiving a plurality of electrical prongs 340 therethrough for connecting to a standard AC wall and/or floor outlet of any home or office for charging electronic devices, cell phones, PDA's MP3 players, shavers, digital cameras, games and other electronic devices. Optionally, the portable USB plug-in module 300 includes a built-in transformer member 350. The transformer member 350 is adjacent to rear wall 314 of module housing 310. Transformer member 350 is sued for changing the voltage(V) from 110 or 220 to low voltages such as 1.5V, 2.5V or 4.0V for connection to low voltages such as 1.5V, 2.5V or 4.0V for connection to low voltage electronic devices.

### Fourth Alternate Embodiment 400

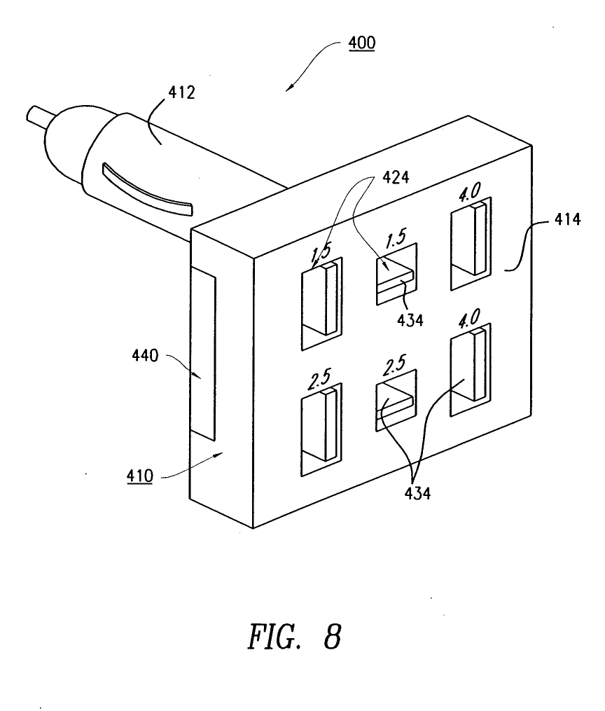

The portable USB car plug-in module 400 and its component parts of the fourth alternate embodiment of the present invention is represented in detail by FIG. 8 of the patent drawings. The portable USB car plug-in module 400 includes a module housing 410 being any shape including T-shaped. The module housing 410 includes a car plug-in section 412 and a USB module section 414 being integrally connected and movable with each other. The car plug-in section 412 is received within a standard vehicle power supply receptacle. The USB module section 414 includes a plurality of USB connector port openings 424 each for receiving a plurality of USB connector ports 434, respectively, therethrough. Optionally, the USB module section 414 includes a built-in transformer member 440 for changing the voltage (V) from 110 or 220 to low voltages such as 1.5V, 2.5V or 4.0V for connection to low voltage electronic devices. The plurality of USB connector ports 434 can vary in size and shape depending upon the type of USB plugs used by the user, as well as varying the voltage power of each USB connector port 434. The portable USB car plug-in module 400 is used in any vehicle in conjunction with the vehicle's power supply receptacle for charging electronic devices, cell phones, PDA's, MP3 players, shavers, digital cameras, games and other electronic devices.

### Fifth Alternate Embodiment 500

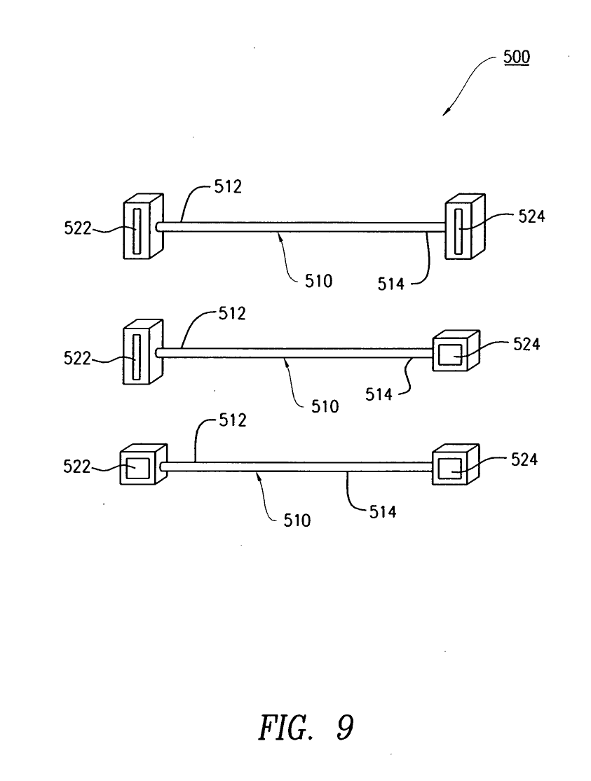

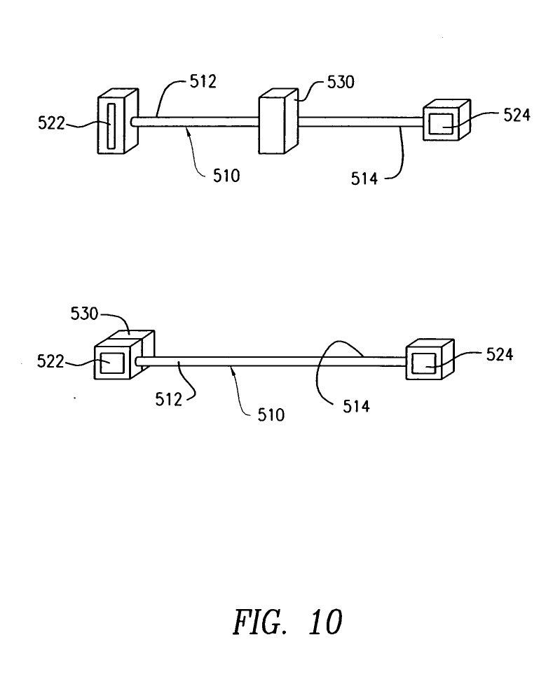

The portable USB cables 500 used in the present invention are represented in detail by FIGS. 9 and 10 of the patent drawings. The portable USB cables 500 for charging electric devices includes a cable member 510 having a first end 512 and a second end 514. The first end 512 includes a first USB port connector 522 and the second end 514 includes a second USB port connector 524. USB connector ports 522 and 524 can vary in size and shape depending upon the type fo USB plugs used by the user. Optionally, USB cable member 510 of portable USB cable 500 includes a transformer member 530 being positioned on cable member 510 between each of the USB connector ports 522 and 524. Additionally, USB connector port 522 can include an optional transformer member 530 being integrally attached to connector port 522, as shown in FIG. 10. The portable USB cables 500 are used in conjunction with charging of electronic devices, cell phones, PDA's, MP3 players, shavers, digital cameras, games and other electronic devices.

### OPERATION OF THE PRESENT INVENTION

As shown in FIGS. 1 and 3, the user simply uses a USB-type plug (not shown) of a peripheral electronic device (not shown) to connect to any one or more of the USB connector ports 26 or 106 of the USB power supply module 24 or 104 of embodiments 10 and 100 for charging of electronic devices, cell phones, PDA's, MP3 players, shavers, digital cameras, games and other electronic devices. The other alternate embodiments 200, 300, 400 and 500 operate in a similar manner.

### ADVANTAGES OF THE PRESENT INVENTION

Accordingly, an advantage of the present invention is that it provides for a USB adaptor device that is used in the pre-wiring of any office or home in order to have wall outlets and/or floor outlets for charging electronic devices, cell phones, PDA's, MP3 players, shavers, digital cameras, games and other electronic devices.

Another advantage of the present invention is that it provides for a USB adaptor device that is in the form of a USB plug-in module for use in conjunction with standard AC receptacle wall outlets and/or floor outlets for charging peripheral electronic devices.

Another advantage of the present invention is that it provides for a USB adaptor device that is in the form of a portable USB power strip for use in conjunction with standard AC receptacle wall outlets and/or floor outlets for charging peripheral electronic devices.

Another advantage of the present invention is that it provides for a USB adaptor device that is in the form of a portable USB car plug-in module for a moving vehicle and for use in conjunction with standard vehicle power supply receptacles in order to charge peripheral electronic devices while driving.

Another advantage of the present invention is that it provides for a USB adaptor device that is easy to use, durable and long-lasting with no moving parts contained therein.

A further advantage of the present invention is that it provides for a USB adaptor device that can be mass-produced in an automated and economical manner and is readily affordable by the consumer.

A latitude of modification, change and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1. A universal serial bus (USB) adaptor device for use in pre-wiring of any office or home in order to have wall outlets and/or floor outlets available for charging electronic devices, comprising:
a) a plate having one or more openings;
b) said openings for receiving a USB power supply module therethrough;
c) said USB power supply module including one or more USB connector ports therein; and
d) said USB connector ports for charging electronic devices including cell phones, PDA's, MP3players, shavers, digital cameras, and games for using a USB-type plug in conjunction with said USB connector port.

2. A USB adaptor device in accordance with claim 1, wherein said USB power supply module includes a transformer member for changing the voltage from 110V or 220V to low voltages such as 1.5V, 2.5V or 4.0V in order to connect to low voltage electronic devices.

3. A universal serial bus (USB) adaptor device for use in pre-wiring of any office or home in order to have wall outlets and/or floor outlets available for charging electronic devices, comprising:
a) a plate having two or more openings;
b) at least one of said openings on said plate for receiving a USB power supply module therethrough;
c) said USB power supply module including one or more USB connector ports therein;
d) said USB connector ports for charging electronic devices including cell phones, PDA's, MP3players, shavers, digital cameras, and games for using a USB-type plug in conjunction with said USB connector port; and
e) at least one of said other openings on said plate for receiving a two or three prong AC receptacle outlet therein.

4. A USB adaptor device in accordance with claim 3, wherein said USB power supply module includes a transformer member for changing the voltage from 110V or 220V to low voltages such as 1.5V, 2.5V or 4.0V in order to connect to low voltage electronic devices.

5. A portable universal serial bus (USB) power strip for use in any office or home in conjunction with AC wall outlets and/or AC floor outlets for charging electronic devices, comprising:
a) a USB power strip having a power strip housing;
b) said housing including a top wall and a side wall;
c) said top wall including a plurality of AC receptacle openings therein;
d) each of said plurality of AC receptacle openings for receiving a two or three prong AC receptacle therein;
e) said top wall including a plurality of USB connector port openings therein;
f) each of said plurality of USB connector port openings for receiving a USB connector port therein;
g) said top wall including a switch opening for receiving a power on/off switch therein and a power-on indicator light;
h) said side wall including a cord opening for receiving a power cord and plug therein; and
i) said USB connector ports for charging electronic devices including cell phones, PDA's, MP3players, shavers, digital cameras, and games for using a USB-type plug in conjunction with said USB connector port.

6. A portable USB power strip in accordance with claim 5, wherein said power strip housing includes a transformer member for changing the voltage from 110V or 220V to low voltages such as 1.5V, 2.5V or 4.0V in order to connect to low voltage electronic devices.

7. A portable universal serial bus (USB) plug-in module for use in pre-wiring any office or home in conjunction with AC wall outlets and/or AC floor outlets for charging electronic devices, comprising:
a) a USB plug-in module having a module housing with a front wall and a real wall;
b) said front wall having an opening for receiving a USB power supply module therein;
c) said USB power supply module including one or more USB connector ports therein;
d) said USB connector ports for charging electronic devices including cell phones, PDA's, MP3players, shavers, digital cameras, and games for using a USB-type plug in conjunction with said USB connector ports; and
e) said rear wall having a plurality of prong openings each for receiving an electrical prong therein for connecting to a standard AC wall outlet and/or AC floor outlet.

8. A portable USB plug-in module in accordance with claim 7, wherein said USB power supply module includes a transformer member for changing the voltage from 110V or 220V to low voltages such as 1.5V, 2.5V or 4.0V in order to connect to low voltage electronic devices.

9. A portable universal serial bus (USB) car plug-in module for any moving vehicle for charging of peripheral electronic devices, comprising:
a) a USB car plug-in module having a module housing;
b) said module housing including a car plug-in section and a USB module section;
c) said USB module section including a plurality of USB connector port openings each for receiving a USB connector port therein;
d) said USB connector ports for charging electronic devices including cell phones, PDA's, MP3players, shavers, digital cameras, and games for using a USB-type plug in conjunction with said USB connector ports; and
e) said car plug-in section being received within a standard vehicle power supply receptacle.

10. A portable USB car plug-in module in accordance with claim 9, wherein said USB module section includes a transformer member for changing the voltage from 110V or 220V to low voltages such as 1.5V, 2.5V or 4.0V in order to connect to low voltage electronic devices.
